(19) United States
(12) Patent Application Publication
(10) Pub. No.: US 2014/0366985 A1
(43) Pub. Date: Dec. 18, 2014

(54) Multijet filler spout with incorporated vent

(71) Applicant: Serac Group, La Ferte Bernard (FR)

(72) Inventor: Jean-Jacques GRAFFIN, Winfield, IL (US)

(21) Appl. No.: 14/307,107

(22) Filed: Jun. 17, 2014

(30) Foreign Application Priority Data
Jun. 17, 2013 (FR) 13 55669

(51) Int. Cl. B67C 3/04; B67C 3/28; B67C 3/26

(52) U.S. Cl. CPC B67C 3/04; B67C 3/2637; B67C 3/28; B67C 2003/2602
USPC 141/286; 141/293; 141/295

(57) ABSTRACT

A spout for filling containers with a liquid is provided. The spout has a body defining a liquid feed duct and has a bottom terminal portion in which there extends firstly a plurality of dispenser channels in communication with the feed duct and secondly an exhaust channel in communication with a vent of the filler spout. The dispenser channels have a flow section that is smaller than the flow section of the feed duct.

### BACKGROUND OF THE INVENTION

1. Field of the Invention

The present invention relates to a filler spout e.g. for mounting in an installation for filling containers. The invention relates more particularly to filling containers to a constant level with a liquid that may be carbonated or non-carbonated.

2. Brief Description of the Related Art

In order to fill containers to a constant level with a non-carbonated liquid, i.e. a “still” liquid, filler spouts are known that comprise: an annular link portion configured to press in leaktight manner against the neck of the container and define a dispensing zone; a feed duct that is connected to a feed source of liquid under a dispensing pressure by means of a dispenser valve member and opening out into the dispensing zone; an exhaust vent opening out firstly into the dispensing zone and secondly to the outside via an orifice for connection to the open air; and an exhaust locking valve controlled by the level of liquid in the exhaust vent, being interposed in the exhaust vent between the dispensing zone and the orifice for connection to the open air. While a container is being filled, the air contained in the container is expelled by the liquid being introduced into the container and it escapes via the orifice connected to the open air. When the liquid reaches the bottom end of the exhaust vent, the liquid rises up the exhaust vent and causes the exhaust blocking valve to close. The dispenser valve member is then closed and the container is separated from the annular link portion so that the liquid contained in the exhaust vent drops back into the container.

Such filler spouts cannot be used for packaging carbonated liquids, i.e. “sparkling” liquids containing dissolved gas, because of the degassing that takes place while the liquid is being introduced into the container.

Document FR-A-2 980 185 discloses a filler spout having a structure that is simple and that enables containers to be filled with a liquid that may be carbonated or non-carbonated. That filler spout includes a discharge channel surrounded by an air exhaust channel.

### BRIEF SUMMARY OF THE INVENTION

In order to avoid an emulsion or a foam forming in the filler spouts, it is known to mount grids therein. Nevertheless, it can happen that such a grid is obstructed or becomes difficult to clean because of the difficulty in accessing the grid.

An object of the present invention is to propose a filler spout of structure that is adapted to filling containers with a liquid that may be carbonated or non-carbonated while avoiding forming an emulsion of the dispensed liquid.

To this end, the invention provides a spout for filling containers with a liquid, the spout comprising a body defining a liquid feed duct and having a bottom terminal portion in which there extend firstly a plurality of dispenser channels in communication with the feed duct and secondly an exhaust channel in communication with a vent of the filler spout, the dispenser channels having a flow section that is smaller than the flow section of the feed duct.

Thus, the stream of liquid flowing in the feed duct is divided in order to penetrate into the dispenser channels and form a plurality of jets at the outlet from the filler spout. It has been found that such an arrangement serves to limit the formation of an emulsion of the liquid. Furthermore, the exhaust channel is incorporated in the bottom end portion, thereby simplifying the structure and the fabrication of the spout. The bottom terminal portion is preferably substantially cylindrical in shape and is preferably taller than it is wide.

Advantageously, an exhaust valve member is mounted in the exhaust channel so as to be movable relative to a seat between a low position in which the valve member is separated from the seat in order to open the exhaust channel, and a high position in which the exhaust valve member presses against the seat in order to close the exhaust channel.

Putting the exhaust valve member directly in place in the exhaust channel extending in the bottom end portion of the spout makes it possible to limit the quantity of liquid that rises up the exhaust circuit before the exhaust valve member closes.

Preferably, the spout includes a primary dispenser valve member movably mounted in the feed duct facing a seat to control the dispensing of liquid, and a secondary dispenser valve member mounted facing an internal transverse wall of the body to be movable between a first position in which the secondary valve member bears against the internal transverse wall and a second position in which the secondary valve member is separated from the internal transverse wall, the dispenser channels opening out in the internal transverse wall in such a manner that the secondary valve member in the closed position closes the dispenser channels, the spout including means for controlling the secondary valve member synchronously with the primary valve member.

The secondary valve member prevents the dispenser channels from emptying and avoids wasting the liquid that is being dispensed.

According to a particular feature, the bottom terminal portion is fastened under a main portion of the body by removable fastener means and, advantageously, the bottom terminal portion is provided with a top collar projecting outwards that is retained between a bottom surface of the main portion of the body and a yoke engaged around the bottom terminal portion and fastened to the main portion of the body.

It is thus easy to replace the bottom terminal portion of the body, e.g. as a function of the inside diameter of the neck of the container, so as to use a bottom terminal portion having the largest possible outside diameter in order to maximize the flow section for the liquid.

Other characteristics and advantages of the invention appear on reading the following description of particular, non-limiting embodiments of the invention.

### BRIEF DESCRIPTION OF THE DRAWINGS

Reference is made to the accompanying drawings, in which:

FIG. 1 is a diagrammatic side view of a filler carousel fitted with filler spouts of the invention;

FIG. 2 is a fragmentary longitudinal section view of a filler spout in accordance with a first embodiment of the invention;

FIG. 3 is a detail view of the terminal portion of the body of that filler spout, in longitudinal section; and

FIG. 4 is a view analogous to FIG. 2 showing a filler spout in accordance with a second embodiment of the invention.

### DETAILED DESCRIPTION OF THE PREFERRED EMBODIMENTS

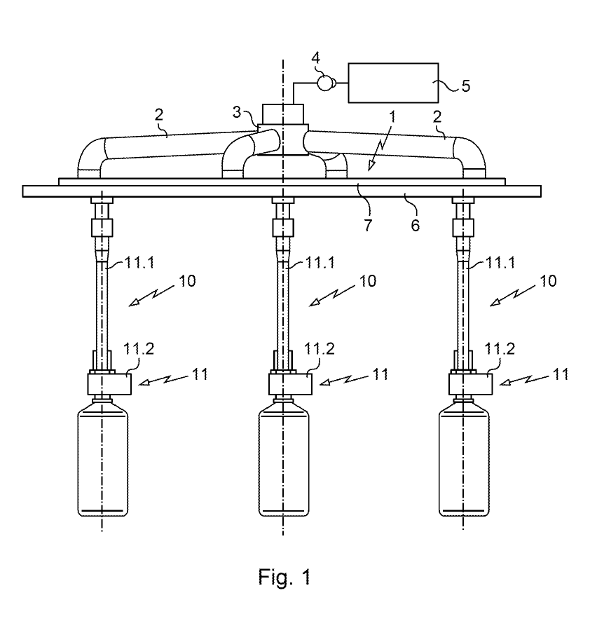

With reference to FIG. 1, the filler carousel of the invention comprises in conventional manner, an annular feed manifold, given overall reference 1, that is fed with liquid under pressure by radial ducts 2, each having one end connected to the feed manifold 1 and an opposite end connected to a rotary joint 3 providing a connection with a pressurized liquid feed source represented by a pump 4 associated with a storage tank shown symbolically at 5. The manifold 1 is formed by an annular groove made in a turntable 6 and closed by an annular cover 7 fastened to the turntable 6. Sealing between the turntable 6 and the cover 7 is provided by O-rings. This arrangement is itself known and is not described in greater detail herein.

Filler spouts given general reference 10 are suspended under the turntable 6. In this example, the filler spouts 10 are identical to one another.

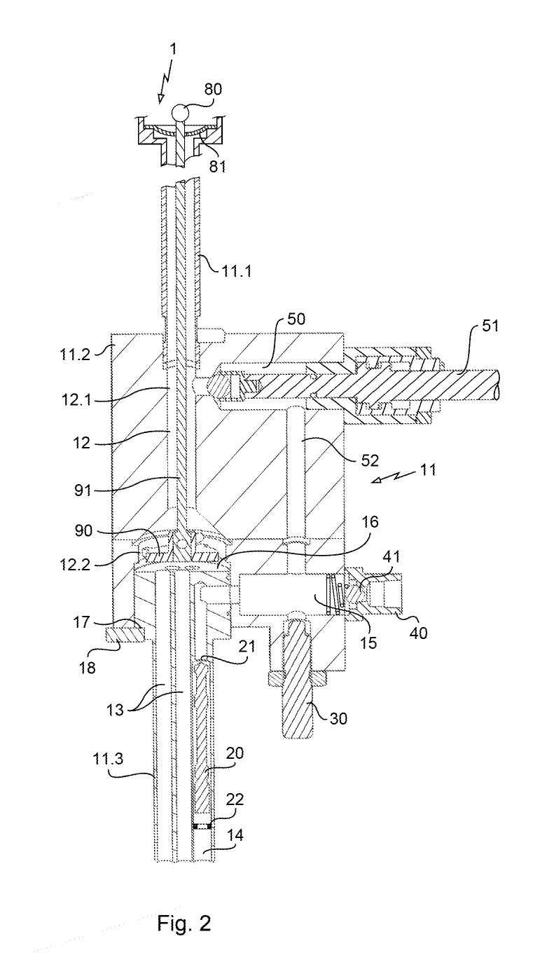

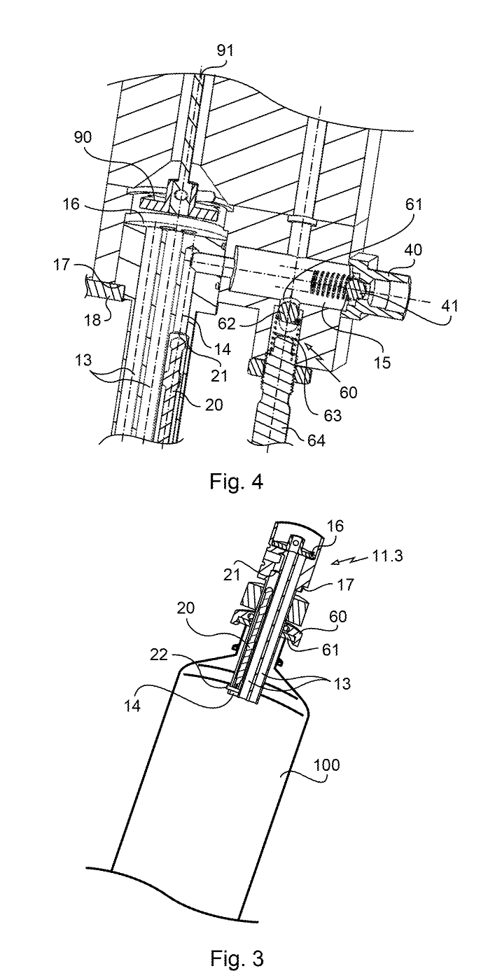

One of the filler spouts 10 in a first embodiment of the invention is described below with reference also to FIGS. 2 and 3. The filler spouts in this first embodiment are adapted to filling containers with a non-carbonated liquid.

Each filler spout 10 comprises a body given overall reference 11, with a top portion 11.1, a central portion 11.2, and a bottom terminal portion 11.3.

The top portion 11.1 is formed by a tube having a top end connected to the admission manifold 1 and a bottom end engaged in the central portion 11.2 of the filler spout.

The central portion 11.2 is formed by a pierced block of a feed duct 12 formed by a vertical bore having a top end 12.1 connected to the bottom end of the top portion 11.1 so as to put the liquid feed duct into communication with the admission manifold 1, and an enlarged bottom end 12.2 that is connected to the bottom terminal portion 11.3.

The bottom terminal portion 11.3 in this example is in the form of a vertical cylinder in which a plurality of dispenser channels 13 extend axially, in communication with the feed duct 12, and an exhaust channel 14 in communication with a vent 15 of the filler spout 10. For an outside diameter of 20 millimeters (mm) of the bottom end portion 11.3, it is possible for example to provide an exhaust channel 14 having a diameter of 6 mm and dispenser channels 13 having a diameter of 5 mm. It should be observed that the bottom terminal portion in this example is cylindrical in shape and taller than it is wide.

The dispenser channels 13 have respective individual flow sections that are smaller than the flow section of the feed duct 12, and that together define a total flow section that in this example is substantially equal to the flow section of the feed duct 12. The dispenser channels 13 each have a top end opening out in a transverse surface 16 extending inside the enlarged bottom end 12.2 of the feed duct 12 and a bottom end opening out at the bottom of the vertical cylinder forming the bottom terminal portion 11.3.

Around the bottom terminal portion 11.3 there extends a gasket carrier bushing 60 that is adjustable in height along the bottom terminal portion 11.3 and that is provided with a sealing gasket 61 for bearing in leaktight manner against a neck of the container 100. The gasket carrier bushing 60 is positioned in such a manner that the bottom terminal portion 11.3 has a free end projecting from the sealing gasket 61 so as to dip into the liquid filling the container 100 at the end of filling. Adjusting the height of the gasket carrier bushing 60 serves to adjust the height of the liquid level in the containers at the end of filling.

The bottom terminal portion 11.3 is fastened under the main portion 11.2 of the body 11 by releasable fastener means. The bottom terminal portion 11.3 is provided with a top collar 17 projecting outwards that is held between a bottom surface of the central portion 11.2 and a yoke 18 that is engaged around the top end of the bottom terminal portion 11.3 and that is fastened to the central portion 11.2 of the body 11.

The exhaust channel 14 has a bottom end opening out at the bottom of the vertical cylinder forming the bottom terminal portion 11.3. An exhaust valve member 20 is mounted in a portion of the exhaust channel 14 extending in register with the dispenser channels in order to move relative to a seat 21 that is constituted by a shoulder in the exhaust channel 14. The exhaust valve member 20 is thus movable between a low position in which the exhaust channel 14 is open and the exhaust valve member 20 is separated from the seat 21 while bearing against a bottom projection 22 of the exhaust channel 14, and a high position closing the exhaust channel 14 in which the exhaust valve member 20 presses against the seat 21. The exhaust valve member 20 is a heavy member that is moved into its closed position under the effect of thrust from liquid rising in the exhaust channel 14, and it is returned to its open position by gravity. The term “heavy” member is used in the invention to mean a valve member of density that is sufficient to ensure that it does not float on the liquid for packaging. Given the small cross-section of the exhaust channel 14, it should be observed that the exhaust valve member 20 in this example is elongate in shape in order to enable it to have sufficient weight. The use of a material of greater density would enable the length of the exhaust valve member 20 to be shortened.

The vent 15 is in permanent communication with the outside, and a pin 30 is mounted in the vent 15 facing a seat 31 to regulate the exhaust of air to the outside via the vent 15, and consequently to regulate the rate at which the container is filled by the liquid.

A member for injecting gas under pressure opens out into the vent 15, which member comprises a bushing 40 having a check valve 41 mounted therein. The bushing 40 is for connecting to a source of gas under pressure (not shown), such as a bottle of nitrogen, via a valve of position that is controlled by a control member such as a wheel associated with a cam (not shown). Because of its weight, the exhaust valve member 20 normally bears against the projection 22. If necessary as a function of the desired filling conditions, gas at a pressure no greater than the exhaust pressure may be injected into the exhaust vent 15 so that the exhaust valve member 20 is pressed against the bottom projection 22 with a force that increases with increasing pressure in the exhaust vent 15.

The central portion 11.2 of the body 11 also has a transverse hole 50 that opens out into the feed duct 12 and that slidably receives a shutter member 51. A link channel 52 extends vertically to connect the transverse hole 50 to the vent 15. During a filling stage, the shutter member 51 is in the closed position. During a cleaning stage, the shutter member 51 is in an open position in order to put the vent 15 into communication with the feed duct 12 in order to enable a cleaning liquid to be conveyed via the feed duct 12 and caused to flow in the filler spout, including in the vent 15 and the exhaust channel 14.

In the zone of the connection between the top portion 11.1 of the body 11 and the manifold 1 there is mounted a primary valve member, represented in this example in the form of a bead 80 that is mounted to move relative to a seat 81 between an open position and a closed position so as to control the dispensing of liquid. The means for controlling this valve are themselves known and are not described in greater detail herein.

The filler spout 10 has a secondary valve member 90 mounted in the enlarged bottom end 12.2 of the feed duct 12 facing the internal transverse wall 16 in order to be movable between a closed position in which the secondary valve member 90 presses against the internal transverse wall 16 and closes the dispenser channels 13, and an open position in which the secondary valve member 90 is separated from the internal transverse wall 16, thereby disengaging the dispenser channels 13. The filler spout 10 includes means for controlling the secondary valve member 90 synchronously with the primary valve member 80 so that the primary valve member 90 and the secondary valve member 90 are simultaneously in their open positions. In this example, the control means comprise a rod 91 connecting the primary valve member 80 to the secondary valve member 90.

It should be observed that the bottom terminal portion 11.3 incorporating the exhaust valve member 20 can be changed quickly.

The filler carousel may be fitted with filler spouts 10 in a second embodiment of the invention. One of these filler spouts is described below with reference to FIG. 4. The filler spout in this second embodiment of the invention are adapted to filling containers with a carbonated liquid.

The filler spout in the second embodiment comprises a body given overall reference 11, having a top portion 11.1, a central portion 11.2, and a bottom terminal portion 11.3 that are all entirely identical to the first embodiment.

The filler spout of the second embodiment differs from the first embodiment in that the pin 30 is replaced by a rated valve 60 comprising a ball 62 held against the seat 61 by a spring 63 that bears against a screw 64. It can be understood that tightening or loosening the screw 64 serves to adjust the tension of the spring. The tension of the spring 63 is adjusted so as to be slightly lower than the filling pressure so as to maintain the gas inside the container under pressure. The pressure difference between liquid admission and the exhaust to air determines the desired correct flow rate.

The other components of the filler spout 10 are identical to those described above.

Naturally, the invention is not limited to the embodiments described but covers any variant coming within the ambit of the invention as defined by the claims.

In particular, the exhaust valve member may be mounted in the central portion 11.2 of the body 11, e.g. in the vent 15.

The body 11 may have a structure that differs from that described. The bottom terminal portion 11.3 may be bolted to the central portion 11.2, the top portion 11.1 and the central portion 11.2 may be made as a single part.

1. A spout for filling containers with a liquid, the spout comprising a body defining a liquid feed duct and having a bottom terminal portion in which there extend firstly a plurality of dispenser channels in communication with the feed duct and secondly an exhaust channel in communication with a vent of the filler spout, the dispenser channels having a flow section that is smaller than the flow section of the feed duct.

2. A spout according to claim 1, wherein an exhaust valve member is mounted in a portion of the exhaust channel extending in register with the dispenser channels so as to be movable relative to a seat between a low position in which the valve member is separated from the seat in order to open the exhaust channel, and a high position in which the exhaust valve member presses against the seat in order to close the exhaust channel.

3. A spout according to claim 1, including a primary dispenser valve member movably mounted in the feed duct in register with a seat to control the dispensing of liquid, and a secondary dispenser valve member mounted in register with an internal transverse wall of the body to be movable between a first position in which the secondary valve member bears against the internal transverse wall and a second position in which the secondary valve member is separated from the internal transverse wall, the dispenser channels opening out in the internal transverse wall in such a manner that the secondary valve member in the closed position closes the dispenser channels, in particular so as to prevent them emptying, the spout including means for controlling the secondary valve member synchronously with the primary valve member.

4. A spout according to claim 3, wherein the control means comprise an actuator rod connecting together the two dispenser valve members.

5. A spout according to claim 1, wherein the bottom terminal portion is fastened under a main portion of the body by removable fastener means.

6. A spout according to claim 5, wherein the bottom terminal portion is provided with a top collar projecting outwards that is retained between a bottom surface of the main portion of the body and a yoke engaged around the bottom terminal portion and fastened to the main portion of the body.
